(19) United States
(12) Patent Application Publication
(10) Pub. No.: US 2025/0305550 A1
(43) Pub. Date: Oct. 2, 2025

(54) BRAKE CALIPER BODY AND BRAKE CALIPER

(71) Applicant: BREMBO S.p.A., Curno (Bergamo) (IT)

(72) Inventors: Alessandro ESPOSITO, Curno (Bergamo) (IT); Alberto MOZZATI, Curno (Bergamo) (IT); Ernestino FORLANI, Curno (Bergamo) (IT)

(73) Assignee: BREMBO S.p.A., Curno (Bergamo) (IT)

(21) Appl. No.: 18/872,954

(22) PCT Filed: Jun. 13, 2023
(86) PCT No.: PCT/IB2023/056068

§ 371 Date: Dec. 9, 2024

(30) Foreign Application Priority Data
Jun. 13, 2022 (IT) 102022000012473

(51) Int. Cl. F16D 65/00; F16D 65/095

(52) U.S. Cl. CPC F16D 65/0056; F16D 65/0068; F16D 65/095

(57) ABSTRACT

A caliper body having a screw seat for accommodating a connecting screw is provided. The screw seat extends along a screw seat direction and is surrounded by a screw head support surface. The caliper body has a pin seat that extends along a pin seat direction and is adapted to accommodate a brake-pad sliding and support pin that is adapted to support and allow a sliding of opposing brake pads. The screw head support surface defines a first screw head support surface extension directed along the screw seat direction. The pin seat defines a second pin seat extension directed along the pin seat direction. The first screw head support surface extension intersects the second pin seat extension.

### FIELD OF THE INVENTION

The present invention relates to a caliper body, a brake caliper, a caliper body and caliper support assembly, as well as to a method of assembling a pad support pin in a caliper body.

### BACKGROUND ART

In a disc brake of known type, the brake caliper is generally arranged astride a brake disc mounted on the hub of a vehicle wheel. The brake caliper usually comprises a caliper body which accommodates the brake pads and actuators for pushing the pads against the disc to achieve the braking action on the vehicle.

In some known disc brake types, the pads are supported by support pins accommodated in appropriate caliper body seats made in the caliper body, in which each support pin passes through corresponding holes made in the support plate for the friction material of each brake pad. Such support pins have a longitudinal extension axis, a pin head, and a pin tip arranged at the opposite ends of the extension axis.

The support pins are coupled with clearance with respect to the respective caliper body seat, and therefore elastic elements are used to axially constrain the pins to the caliper body seats.

In some cases, such elastic elements are coaxially pre-assembled to the pin body in an annular pin seat. The annular pin seat, in which the elastic element is accommodated, includes a usually cylindrical bottom wall with axial extension, axially delimited by at least a first seat wall substantially transverse to the bottom wall minus flared machining connectors.

Such elastic elements are usually expanding elastic elements, and in a resting condition, have a larger radial dimension than the radial dimension of the first seat wall. When the support pin provided with the expanding elastic element is assembled to the caliper body, the expanding elastic element is thus radially compressed by the walls of the caliper body seat in the direction of the support pin, and the expanding elastic element is constrained by friction to the caliper body seat. As a result, the expanding elastic element provides an axial constraint aimed at preventing the pin from coming out of its seat.

The expanding elastic element is inserted by sliding into the caliper body seat, e.g., under a thrust action. Once the expanding elastic element is positioned inside the caliper body seat, and at least one pin abutment portion of the support pin axially abuts against the caliper body defining the maximum insertion position of the pin in the caliper body, the elastic element forms an axial constraint with respect to the pin, thus preventing the movements of the pin in the extraction direction until the action in the axial direction applied by the first seat wall of the pin seat exceeds the static friction force between the elastic element and the caliper body, allowing the elastic element to slide with respect to the caliper body and therefore allowing the pin to come out of its seat.

For example, document EP1425520 to the Applicant shows a brake pad support pin coupled to a barrel-shaped expanding elastic element.

The shape of the support pins and the respective expanding elastic elements is such as to meet the need to ensure an easy assembly of a brake caliper assembly, as well as a simple replacement of the brake pads, e.g., during maintenance, while meeting the need to ensure an axially constrained coupling between the support pins and the caliper body when the vehicle is used, while withstanding the operating biases.

According to a further aspect, in order to ensure the correct axial positioning of the support pin and elastic element assembly, the pad support pins of known type are machined to have a pin abutment portion which, when the support pin has reached its maximum axial insertion position, axially abuts against the caliper body, and the expanding elastic element, forming a radial seal with the caliper body, prevents the unwanted release of the support pin from the caliper body.

The pad support pins are machined in different manners to obtain different pin abutment portions according to the type of caliper body on which they must be mounted, e.g., on monobloc caliper bodies or on caliper bodies having two caliper half-bodies assembled together. Consistently, the caliper body seats in which the pin tip and the pin head are accommodated, respectively, have different shapes according to the type of caliper body.

Some types of pad support pins have, at the pin tip end, a pin abutment portion, i.e., a shoulder, having a larger radial dimension than a pin tip end portion with small diameter, so that it abuts against the caliper body when the pin is inserted into the caliper body, reaching its maximum axial insertion position.

In other types of pad support pins, the pin portion in which the annular seat is obtained, in which the elastic element is arranged, has a larger radial dimension than the rest of the pin and thus has, in the direction of the pin tip, a pin fitting shoulder shaped to abut against a caliper body seat shoulder so that it abuts against the caliper body when the pin is inserted into the caliper body, reaching its maximum axial insertion position. In such a case, the caliper body seat accommodating the pin portion in which the annular seat is obtained usually comprises a first cylindrical portion and a second cylindrical portion having different diameters, which are connected by the shoulder of the caliper body seat.

Although such pad support pins and the corresponding elastic elements meet the needs of obtaining simple assembly and easy maintenance, it has been found that the mechanical operations for defining the pin abutment portions make the manufacturing of the support pins particularly complex and have a significant impact on the final cost and processing time.

Therefore, the need is strongly felt in the field to make pad support pins which are easy to manufacture and which allow reducing the production costs per piece, while allowing the standardization of the geometry of the pins for different types of calipers, thus further facilitating the processes of assembling such assemblies in respective caliper bodies.

Therefore, the problem underlying the present invention is to devise a caliper body, pin and elastic element assembly, as well as a brake caliper, a pin assembly, a caliper body, and a method for assembling a pad support pin in a caliper body of a vehicle, which have structural and functional features to meet the aforesaid needs while solving the drawbacks mentioned with reference to the prior art and meet the aforesaid needs.

### Solution

It is the object of the present invention to provide a caliper body, as well as a brake caliper, as well as a caliper and caliper support assembly, as well as a method of assembling a pad support pin in a caliper body of a vehicle, which are easy to manufacture and obtain while allowing easy maintenance and assembly, as well as the highest certainty for the pin not to accidentally come out of its seat when using the brake caliper.

This and other objects and advantages are achieved by a caliper body according to claim 1, as well as a brake caliper according to claim 9, as well as an assembly according to claim 8, as well as a caliper body according to claim 20, as well as a method of mounting a pad support pin in a caliper body of a vehicle according to claim 21.

Some advantageous embodiments are the subject of the dependent claims.

The analysis of this solution shows how the suggested solution allows simplifying the machining of the support pins while maintaining an easy, correct positioning of the support pin inside the caliper body.

Moreover, the suggested solution reduces manufacturing costs by reducing the pin portions which must be machined after drawing.

Furthermore, the suggested solutions allow standardizing the different types of pins and the different types of pin seats made in the caliper body, further reducing manufacturing costs and simplifying the assembly operations.

Moreover, the suggested solutions ensuring the highest certainty for the pin not to be accidentally removed from its seat during use.

### DRAWINGS

Further features and advantages of the caliper body, brake caliper, assembly and assembly method are given by way of a non-limiting example, with reference to the accompanying drawings, in which:

FIG. 1 shows an axonometric view of a brake caliper mounted on a caliper support;

FIG. 2 shows an axonometric view, in separate parts, of the assembly in FIG. 1;

FIG. 3 shows an axonometric view, in separate parts, of the assembly in FIG. 1, according to a different point of view;

FIG. 4 shows an axonometric view of a brake caliper according to the invention;

FIG. 5 shows an axonometric view of a caliper body according to the invention;

FIG. 6 shows a front view of the caliper body in FIG. 5;

FIG. 7 shows an axonometric view sectioned by a plane directed according to the radial and axial direction passing through the pin seat, of the brake caliper in FIG. 4 in which a connecting screw is mounted;

FIG. 8 shows an axonometric view, sectioned by a plane directed according to the radial and axial direction passing through the pin seat, of the brake caliper in FIG. 4 in which the connecting screw is removed from its seat and the pin is removed from its seat;

FIG. 9 shows an axonometric view, sectioned by a plane passing through the circumferential and radial direction, of the caliper in FIG. 4 in which a connecting screw is inserted;

FIG. 10 shows an axonometric view, sectioned by a plane passing through the circumferential and radial direction, of the caliper in FIG. 4 in which a connecting screw is inserted, according to a different point of view;

FIG. 11 shows an axonometric view of the assembly of the brake pads, pad spring, brake-pad sliding and support pin and connecting screw depicted in operating position;

FIGS. 12 and 13 show an axonometric view of the caliper in FIG. 4, sectioned according to a plane passing through the radial and axial direction in which two pin disassembly steps are depicted, first removing the connecting screw and then removing the pin;

FIGS. 14, 15 and 16 show an axonometric view of a portion of the caliper in FIG. 4, in three steps of mounting a pin, first including the insertion of the pin into its seat and then the insertion of the connecting screw into its seat so as to obstruct the removal path of the pin.

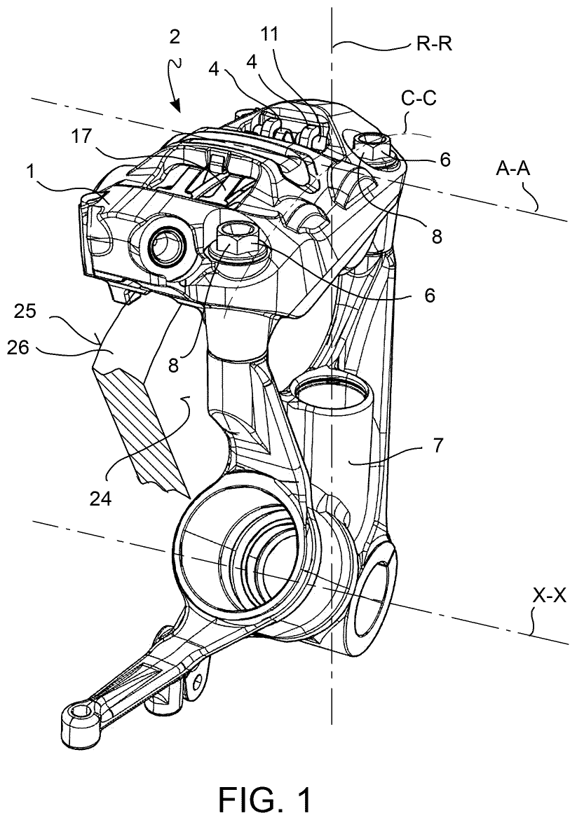

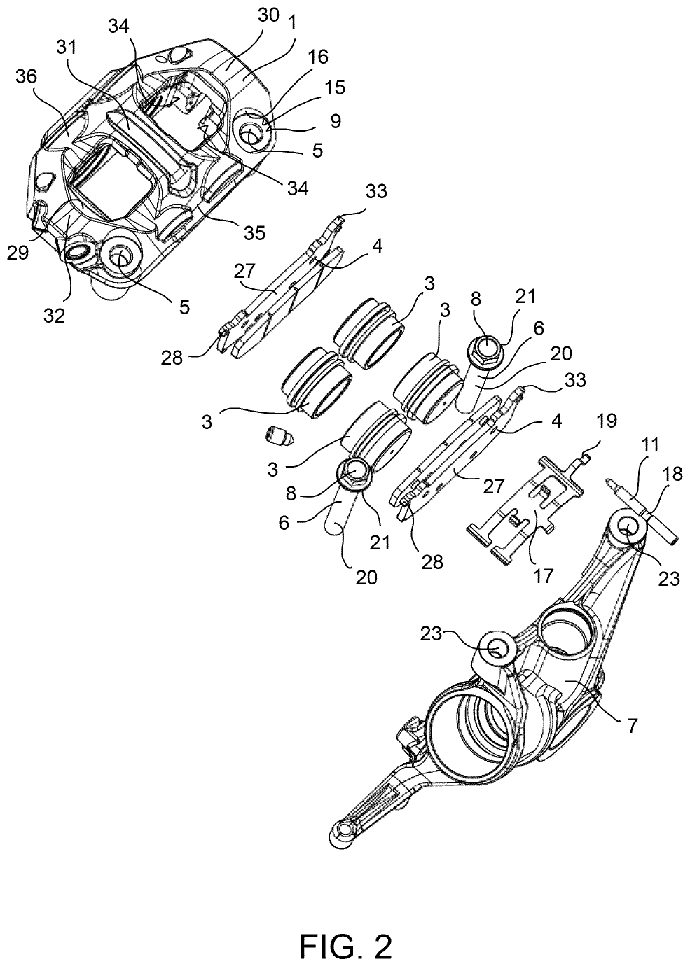

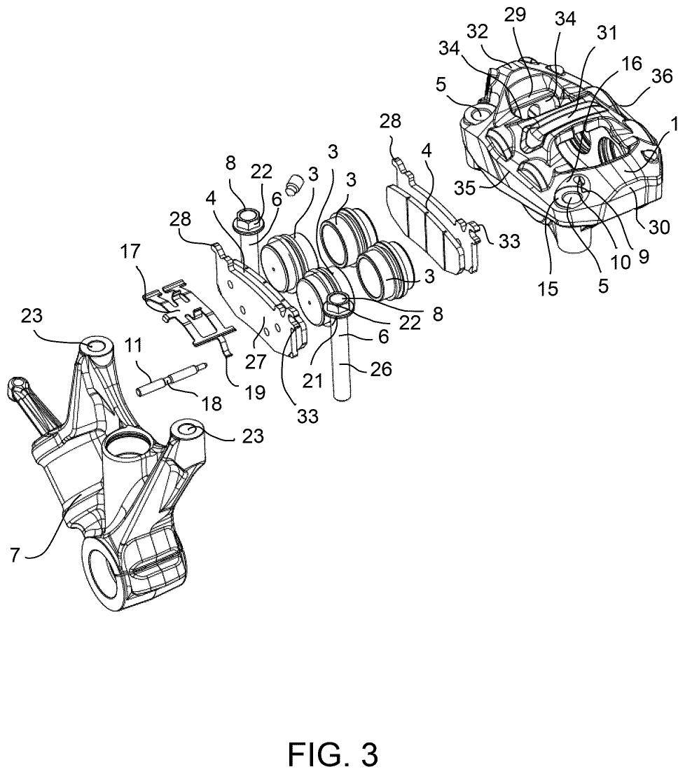

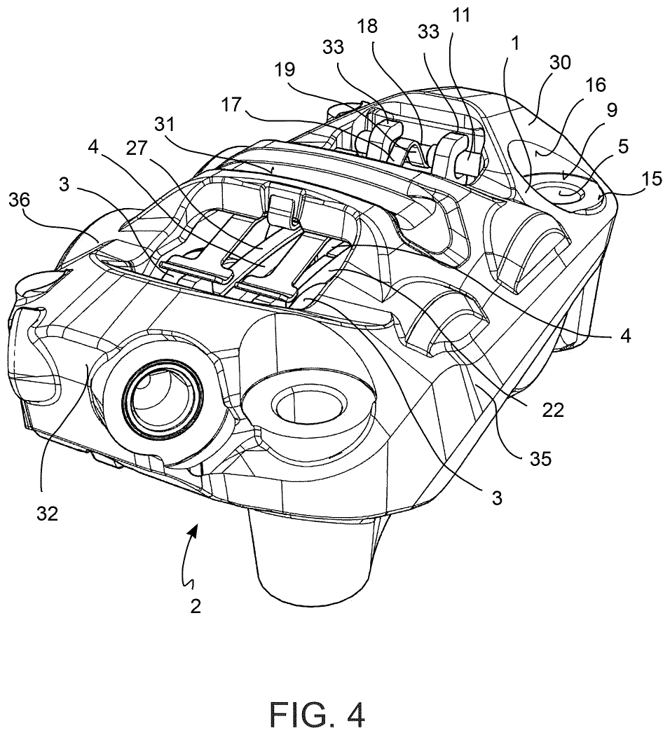

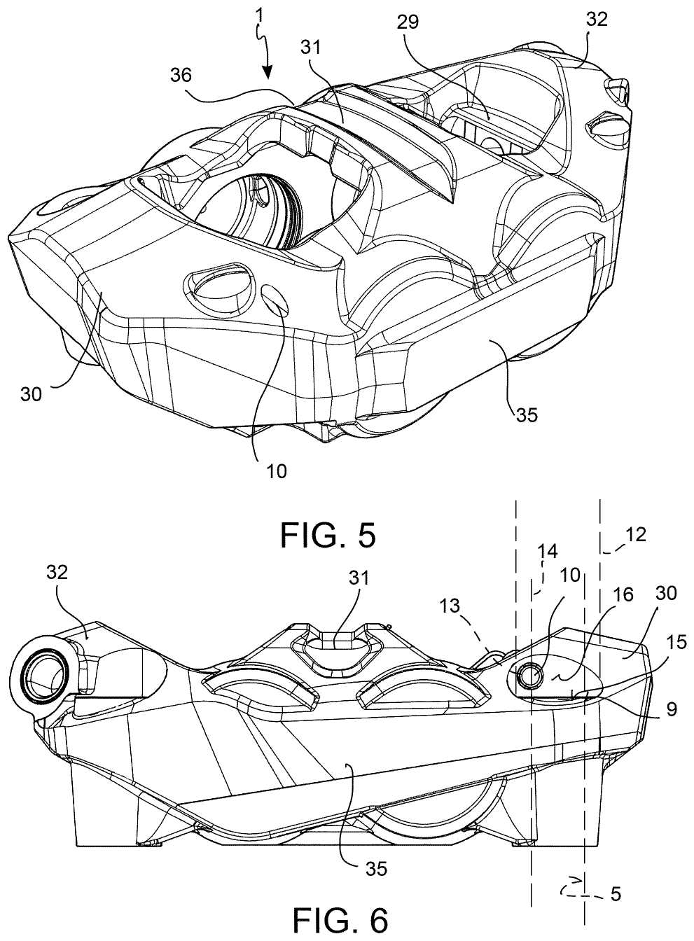

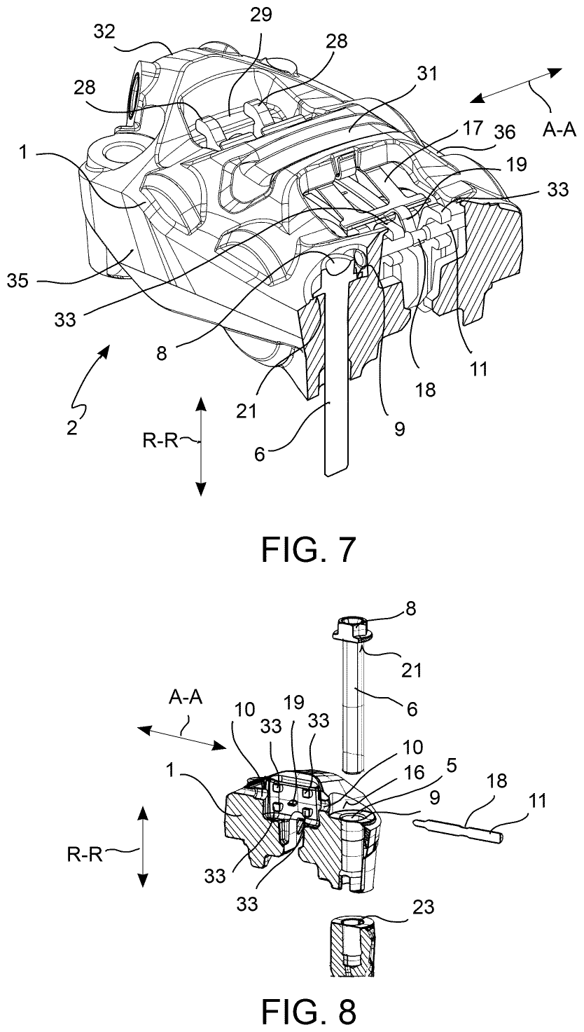

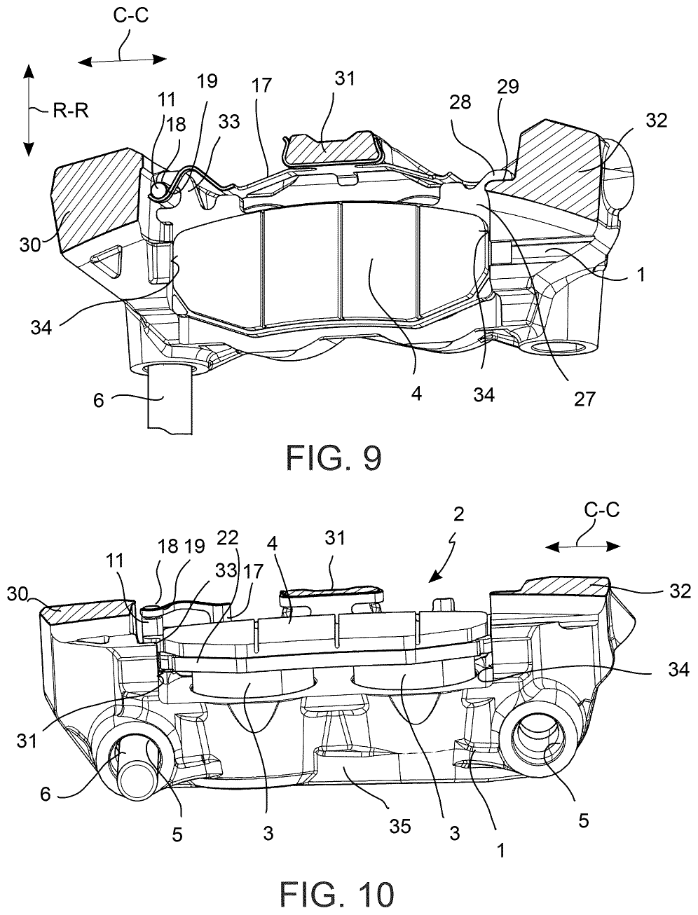

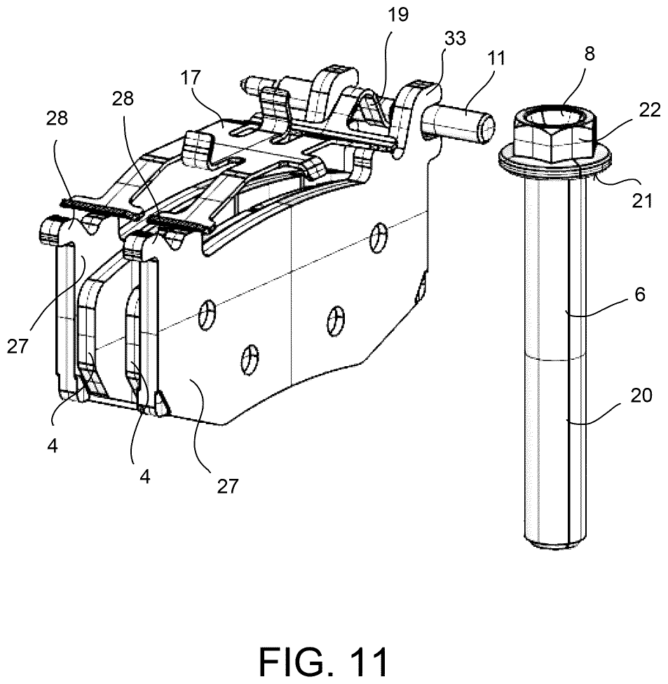

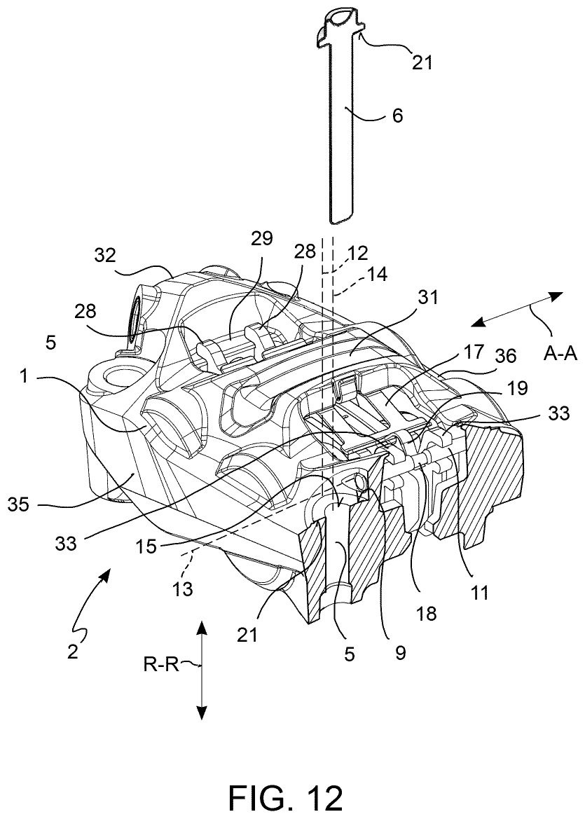

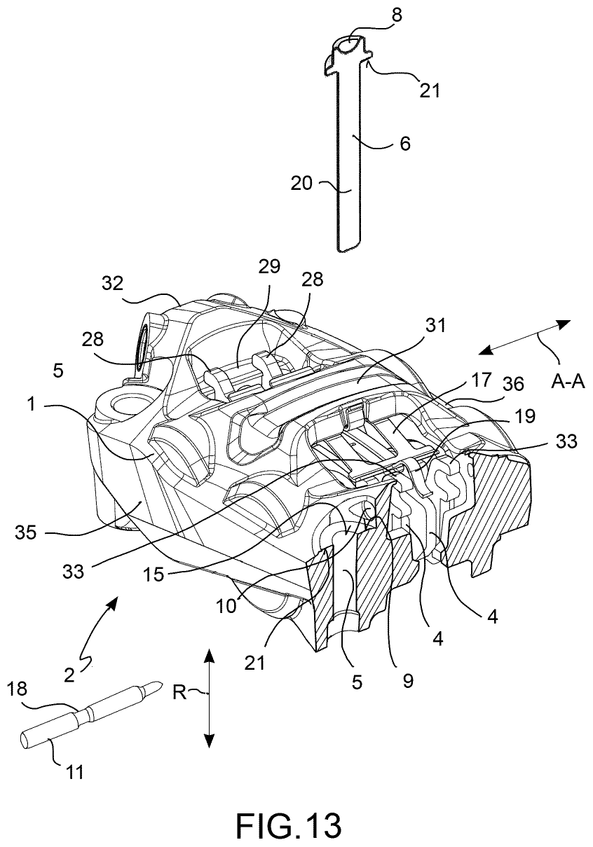

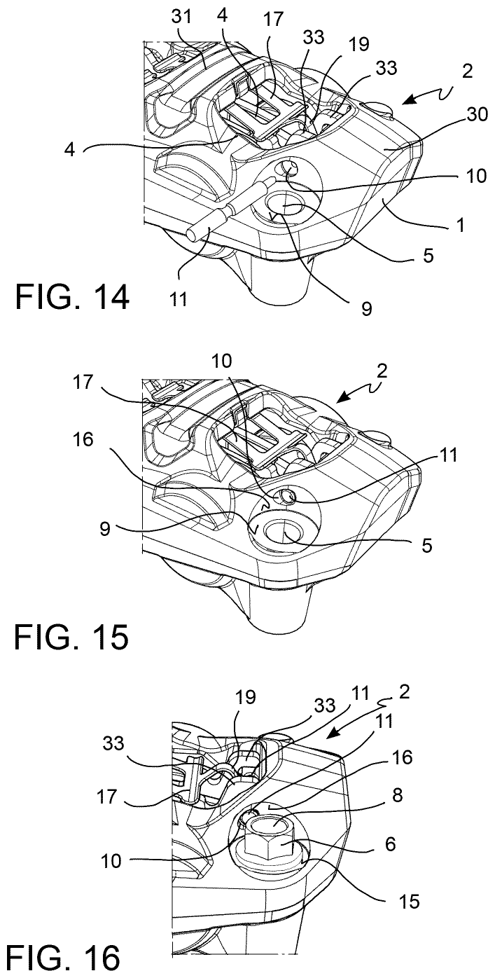

### DESCRIPTION OF SOME PREFERRED EMBODIMENTS

According to a general embodiment, a caliper body 1 of a brake caliper 2 is adapted to house thrust means 3 for urging opposing brake pads 4 against opposite braking surfaces 24, 25 of a brake disc 26 on which said caliper body 1 is adapted to be arranged astride.

Said brake disc 26 defines an axial direction A-A parallel to or coincident with a rotation axis X-X of said brake disc 26, a radial direction R-R orthogonal to said rotation axis X-X, and a circumferential direction C-C which, in each intersection point between said axial direction A-A and said radial direction R-R, is orthogonal to both said axial direction A-A and said radial direction R-R.

Said caliper body 1 comprises at least one screw seat 5 to accommodate a connecting screw 6 for connecting the caliper body 1 to a caliper support 7.

Said screw seat 5 extends along a screw seat direction S-S.

Said connecting screw 6 comprises a screw head 8 to support and tighten the connecting screw 6 and connect said caliper body 1 to said caliper support 7.

Said at least one screw seat 5 is surrounded by a screw head support surface 9 adapted to support said screw head 8 and tighten said connecting screw 6.

Said screw head support surface 9 defines a first screw head support surface extension 12 directed along said screw seat direction S-S.

Said caliper body 1 comprises at least one pin seat 10 adapted to accommodate a brake-pad sliding and support pin 11. Said pin 11 is adapted to support and allow the sliding of opposing brake pads 4. Said pin 11 is extractable to allow the disassembly and replacement of the brake pads 4 when they are worn, for example.

Said at least one pin seat 10 extends along a pin seat direction P-P.

Said at least one pin seat 10 defines a second pin seat extension 13 directed along said pin seat direction P-P.

Said first screw head support surface extension 12 intersects said second pin seat extension 13.

By virtue of the intersection between the first screw head support surface extension 12 and the second pin seat extension 13, certainty can be doubled and it is possible to ensure that the pin 11 does not to come out of its pin seat 10 during the operation of the brake caliper 2. In particular, the invention provides that the function of ensuring that the pin 11 does not come out of its seat 10 is performed by the connecting screw 6 connecting the caliper body 1 to the vehicle.

According to an embodiment, the pin seat 10, on the side opposite to the connecting screw 6, includes a narrowing to allow a widened portion of said pin 11 to abut in its seat and prevent it from coming out of the side of the caliper body opposite to said connecting screw 6.

According to an embodiment, said at least one pin seat 10 opens towards and seamlessly faces said first screw head support surface extension 12 so that when said connecting screw 6 is not accommodated in said at least one screw seat 5, said at least one pin seat 10 can be freely accessed.

According to an embodiment, said at least one screw seat 5 defines a third screw seat extension 14 directed along said screw seat direction S-S.

Said third screw seat extension 14 intersects said second pin seat extension 13.

According to an embodiment, said at least one pin seat 10 is an at least partially cylindrical seat.

Said at least one screw seat 5 is an at least partially cylindrical seat.

According to an embodiment, said screw head support surface 9 is an annular crown.

According to an embodiment, said screw head support surface 9 is obtained in a flattened caliper body portion 15 formed in said caliper body 1 and which forms at least one flattened portion side wall 16, for example resting on a cylindrical extension, which at least partially surrounds said screw head support surface 9.

According to an embodiment, looking transversely to a circumferential C-C and radial R-R plane (see FIG. 6), the mouth of said at least one pin seat 10 is completely visible without obstructions of portions or components of the caliper body 1. Access to the pin seat 10 is thus free for said pin 11 when the connecting screw 6 is removed, but is impossible when the connecting screw 6 is in its screw seat 5, thus blocking the pin 11 in its pin seat 10.

According to an embodiment, said caliper body 1 is a body made in one piece forming three connection bridges 30, 31, 32 which connect two opposite elongated elements 35, 36, in each of which two seats 22, 23 for thrust means 3 are obtained.

According to an embodiment, said screw seat direction S-S is a radial direction R-R or a direction parallel to a radial direction R-R, preferably the radial direction R-R passing through the centerline of the caliper body 1 or through the thrust center of one of the brake pads 4.

Said pin seat direction P-P is an axial direction A-A or a direction parallel to an axial direction A-A.

The present invention also relates to a brake caliper 2 comprising a caliper body 1 according to any one of the embodiments described above. Opposing brake pads 4 elastically biased by at least one pad spring 17 are accommodated in said brake caliper 2.

Said pads are supported by and slide on at least one brake-pad sliding and support pin 11.

According to an embodiment, said pad spring 17 elastically biases said brake-pad sliding and support pin 11 with an elastic action, for example, an elastic action directed in the radial R-R and/or circumferential C-C direction.

According to an embodiment, said brake-pad sliding and support pin 11 comprises an annular pin seat 18.

Said pad spring 17 comprises a spring portion 19, or tab, at least partially inserted into said annular pin seat 18 so as to counteract excessive movements of said brake-pad sliding and support pin 11 along the axial direction A-A.

According to an embodiment, at least one connecting screw 6 connects said caliper body 1 to a caliper support 7.

According to an embodiment, said connecting screw 6 is a screw stud.

According to an embodiment, said connecting screw 6 comprises a screw head 8.

Said screw head 8 comprises a screw head support and tightening surface 21 which rests against said screw head support surface 9 when the screw is tightened. The screw head 8 thus at least partially intersects said second pin seat extension 13.

According to an embodiment, said screw head 8 comprises grip surfaces 22 for maneuvering said connecting screw 6.

According to an embodiment, said connecting screw 6 comprises a screw shank 20 for the connection with said screw seat 5 and with a caliper support screw seat 23 provided in said caliper support 7.

According to an embodiment, said pad spring 17 is connected to the caliper body 1 and biases said brake pads resting on said caliper body 1 in a circumferential direction C-C and away from the brake disc 26 in the axial direction A-A.

According to an embodiment, said brake pads 4 each comprise a support plate 27.

Said support plate 27 comprises a support arm 28 for supporting said support plate 27 on the pad surface 29 provided in said caliper body 1.

According to an embodiment, said pad surface 29 faces said brake pads 4 and protrudes from an end bridge 30.

According to an embodiment, said brake pads 4 each comprise a support plate 27.

Said support plate 27 comprises a support fork 33 placed astride said brake-pad sliding and support pin 11.

According to an embodiment, said caliper body 1 comprises plate support elements 34 which are directed radially R-R or according to a direction parallel to a radial direction R-R, for example, passing through the centerline or pressure center of the brake pad 4, adapted to support the support plates 27 and to react to the braking action.

The present invention also relates to a brake caliper assembly comprising a brake caliper 2 according to any one of the embodiments described above, and to a caliper support 7.

Said caliper support 7 comprises at least one caliper support screw seat 23 for accommodating a screw shank 20 of a connecting screw 6 which connects said caliper body 1 to said caliper support 7.

The present invention also relates to a method of mounting brake pads 4 in a caliper body 1.

This method comprises at least the following steps:
providing a brake caliper 2 as defined in any one of the embodiments described above;
with the caliper body 1 disassembled, connecting said pad spring 17 to said caliper body 1;
with the caliper body 1 disassembled, inserting the brake pads 4 into the caliper body 1 so as to engage the support arm 28 thereof to said pad surface 29;
inserting said brake-pad sliding and support pin 11 into

said pin seat 10 by positioning the support forks 33 astride said pin 11 and at least partially inserting said spring portion 19 into said annular pin seat 18;
inserting said connecting screw 6 into said screw seat 5, thus at least partially obstructing access to said pin 18 so that the screw head 8 at least partially intersects said second pin seat extension 13.

### LIST OF REFERENCE SIGNS

1 caliper body
2 brake caliper
3 thrust means
4 brake pad
5 screw seat
6 connecting screw
7 caliper support
8 screw head
9 screw head support surface
10 pin seat
11 brake-pad sliding and support pin
12 first screw head support surface extension
13 second pin seat extension
14 third screw seat extension
15 flattened caliper body portion
16 flattened portion side wall
17 pad spring
18 annular pin seat
19 spring portion or tab
20 screw shank
21 screw head support and tightening surface
22 grip surfaces
23 caliper support screw seat
24 braking surface
25 braking surface
26 brake disc
27 support plate
28 support arm
29 pad surface
30 end bridge
31 intermediate bridge
32 end bridge
33 support fork
34 plate support element
35 elongated caliper body element
36 elongated caliper body element
A-A axial direction
X-X rotation axis
R-R radial direction
C-C circumferential direction
P-P pin seat direction
S-S screw seat direction

1-21. (canceled)

22. A caliper body of a brake caliper adapted to house thrust means for urging opposing brake pads against opposite braking surfaces of a brake disc on which said caliper body is adapted to be arranged astride, said brake disc defining an axial direction parallel to or coincident with a rotation axis of said brake disc, a radial direction orthogonal to said rotation axis and a circumferential direction which, in each intersection point between said axial direction and said radial direction, is orthogonal to both said axial direction and said radial direction, wherein
said caliper body comprises at least one screw seat to accommodate a connecting screw for connecting the caliper body to a caliper support, said at least one screw seat extends along a screw seat direction, and said connecting screw comprises a screw head to support and tighten the connecting screw by connecting said caliper body to said caliper support;
said at least one screw seat is surrounded by a screw head support surface adapted to support said screw head and tighten said connecting screw;
said caliper body further comprises at least one pin seat adapted to accommodate a brake-pad sliding and support pin that is adapted to support and allow a sliding of said brake pads, said at least one pin seat extending along a pin seat direction;
said screw head support surface defines a first screw head support surface extension directed along said screw seat direction;
said at least one pin seat defines a second pin seat extension directed along said pin seat direction, and wherein
said first screw head support surface extension intersects said second pin seat extension.

23. The caliper body of claim 22, wherein said at least one pin seat opens towards and seamlessly faces said first screw head support surface extension so that, when said connecting screw is not accommodated in said at least one screw seat, said at least one pin seat is freely accessible.

24 The caliper body of claim 22, wherein said at least one screw seat defines a third screw seat extension directed along said screw seat direction, and wherein said third screw seat extension intersects said second pin seat extension.

25. The caliper body of claim 22, wherein
said at least one pin seat is an at least partially cylindrical seat, wherein
said at least one screw seat is an at least partially cylindrical seat, and wherein
said screw head support surface is an annular crown.

26. The caliper body of claim 22, wherein said screw head support surface is obtained in a flattened caliper body portion formed in said caliper body and which forms at least one flattened portion side wall which at least partially surrounds said screw head support surface.

27. The caliper body of claim 22, wherein, looking at said at least one pin seat transversely to a circumferential and radial plane, said at least one pin seat is completely visible without obstructions of portions or components of the caliper body.

28. The caliper body of claim 22, wherein said caliper body is a body made in one piece forming three connection bridges that connect two opposite elongated elements in each of which two seats for the thrust means are provided.

29. The caliper body of claim 22, wherein
said screw seat direction is the radial direction or a direction parallel to the radial direction, preferably the radial direction passing through a centerline of the caliper body or through a thrust center of one of the brake pads, and wherein
said pin seat direction is the axial direction or a direction parallel to the axial direction.

30. A brake caliper comprising a caliper body adapted to house thrust means for urging opposing brake pads against opposite braking surfaces of a brake disc on which said caliper body is adapted to be arranged astride, said brake disc defining an axial direction parallel to or coincident with a rotation axis of said brake disc, a radial direction orthogonal to said rotation axis and a circumferential direction which, in each intersection point between said axial direction and said radial direction, is orthogonal to both said axial direction and said radial direction, wherein
said caliper body comprises at least one screw seat to accommodate a connecting screw for connecting the caliper body to a caliper support, said at least one screw seat extends along a screw seat direction, and said connecting screw comprises a screw head to support and tighten the connecting screw by connecting said caliper body to said caliper support;
said at least one screw seat is surrounded by a screw head support surface adapted to support said screw head and tighten said connecting screw;
said caliper body further comprises at least one pin seat adapted to accommodate a brake-pad sliding and support pin that is adapted to support and allow a sliding of said brake pads, said at least one pin seat extending along a pin seat direction;
said screw head support surface defines a first screw head support surface extension directed along said screw seat direction;
said at least one pin seat defines a second pin seat extension directed along said pin seat direction, wherein
said first screw head support surface extension intersects said second pin seat extension, wherein
the brake pads are accommodated, elastically biased by at least one pad spring, and wherein
said brake pads are supported by and slide on the brake-pad sliding and support pin.

31. The brake caliper of claim 30, wherein said pad spring elastically biases said brake-pad sliding and support pin with an elastic action, preferably an elastic action directed in the radial direction and/or the circumferential direction.

32. The brake caliper of claim 30, wherein
said brake-pad sliding and support pin comprises an annular pin seat, and wherein
said pad spring comprises a spring portion at least partially inserted into said annular pin seat so as to counteract excessive movements of said brake-pad sliding and support pin along the axial direction.

33. The brake caliper of claim 30, wherein the connecting screw connects said caliper body to the caliper support.

34. The brake caliper of claim 33, wherein said connecting screw is a screw stud.

35. The brake caliper of claim 30, wherein
said screw head comprises a screw head support and tightening surface which, when the connecting screw is tightened, rests against said screw head support surface, wherein the screw head at least partially intersects said second pin seat extension, and/or wherein
said screw head comprises grip surfaces for maneuvering said connecting screw.

36. The brake caliper of claim 33, wherein said connecting screw comprises a screw shank for connection with said at least one screw seat and with a caliper support screw seat provided in said caliper support.

37. The brake caliper of claim 30, wherein said pad spring is connected to the caliper body and biases said brake pads resting on said caliper body in the circumferential direction and away from the brake disc in the axial direction.

38. The brake caliper of claim 30, wherein
said brake pads each comprise a support plate, and wherein
said support plate comprises a support arm for supporting said support plate on a pad surface provided in said caliper body facing said brake pads and protruding from an end bridge.

39. The brake caliper of claim 30, wherein
said brake pads each comprise a support plate, and wherein
said support plate comprises a support fork placed astride said brake-pad sliding and support pin.

40. The brake caliper of claim 38, wherein said caliper body comprises plate support elements directed radially or according to a direction parallel to the radial direction, preferably passing through a centerline or pressure center of the brake pads, adapted to support the support plates and to react to a braking action.

41. A brake caliper assembly comprising the brake caliper of claim 30 and a caliper support, wherein said caliper support comprises at least one caliper support screw seat for accommodating a screw shank of the connecting screw that connects the caliper body to said caliper support.

42. A method of mounting brake pads in a caliper body, the method comprising:
providing a brake caliper comprising a caliper body adapted to house thrust means for urging opposing brake pads against opposite braking surfaces of a brake disc on which said caliper body is adapted to be arranged astride, said brake disc defining an axial direction parallel to or coincident with a rotation axis of said brake disc, a radial direction orthogonal to said rotation axis and a circumferential direction which, in each intersection point between said axial direction and said radial direction, is orthogonal to both said axial direction and said radial direction, wherein
said caliper body comprises at least one screw seat to accommodate a connecting screw for connecting the caliper body to a caliper support, said at least one screw seat extends along a screw seat direction, and said connecting screw comprises a screw head to support and tighten the connecting screw by connecting said caliper body to said caliper support;
said at least one screw seat is surrounded by a screw head support surface adapted to support said screw head and tighten said connecting screw;
said caliper body further comprises at least one pin seat adapted to accommodate a brake-pad sliding and support pin that is adapted to support and allow a sliding of said brake pads, said at least one pin seat extending along a pin seat direction;
said screw head support surface defines a first screw head support surface extension directed along said screw seat direction;
said at least one pin seat defines a second pin seat extension directed along said pin seat direction, wherein
said first screw head support surface extension intersects said second pin seat extension, wherein
the brake pads are accommodated, elastically biased by at least one pad spring, and wherein
said brake pads are supported by and slide on the brake-pad sliding and support pin;
with the caliper body disassembled, connecting said pad spring to said caliper body;
with the caliper body disassembled, inserting the brake pads into the caliper body so as to engage a support arm of the brake pads to a pad surface provided in said caliper body;
inserting said brake-pad sliding and support pin into said at least one pin seat by positioning support forks astride said brake-pad sliding and support pin and at least partially inserting a spring portion of the pad spring into an annular pin seat of the brake-pad sliding and support pin; and
inserting said connecting screw into said at least one screw seat, at least partially obstructing access to said brake-pad sliding and support pin so that the screw head at least partially intersects said second pin seat extension.
